(19) United States
(12) Patent Application Publication
(10) Pub. No.: US 2025/0139682 A1
(43) Pub. Date: May 1, 2025

(54) SYSTEMS AND METHODS FOR SEASONALITY/EVENT-BASED RENTAL RECOMMENDATIONS

(71) Applicant: Wells Fargo Bank, N.A., San Francisco, CA (US)

(72) Inventor: Erin Aine Croll, Des Moines, IA (US)

(21) Appl. No.: 18/497,792

(22) Filed: Oct. 30, 2023

(51) Int. Cl. G06Q 30/0601; G06Q 30/0201; G06Q 30/0645; G06Q 50/16

(52) U.S. Cl. CPC G06Q 30/0631; G06Q 30/0206; G06Q 30/0645; G06Q 50/16

(57) ABSTRACT

Systems, apparatuses, methods, and computer program products are disclosed for rental optimization of real estate. An example method includes detecting, by an event monitoring engine, an occurrence of a trigger event. The example method further includes defining, by the event monitoring engine and based on a trigger event attribute set, an area of interest, and identifying, by a prospect engine, a rentable unit within the area of interest that corresponds to a trigger event type attribute. The example method further includes generating, by the prospect engine and based on the trigger event attribute set, a rental price prediction for the rentable unit, if the rental price prediction satisfies a predefined rental price threshold, generating, by the prospect engine, a personalized rental recommendation for the rentable unit, and outputting, by communications hardware, a rental prompt based on the personalized rental recommendation.

### BACKGROUND

Rental management apps may be used to manage and automate the process of renting a property. This technology allows terminal entities (e.g., users, rental companies) to list their properties, and aids the entities with tracking rental inventory and reservations, generating invoices, processing payments and maintaining customer information.

### BRIEF SUMMARY

As discussed above, rental optimization systems have become increasingly important as the real estate and property management industries embrace technology to streamline processes, improve customer experiences, and boost returns on investments. While these systems are especially valuable for a terminal entity dealing with vacation rentals, apartment complexes, short-term rentals, and other types of real estate, the full extent of rental optimization systems is still being explored.

The digital market for rental management systems is dominated by apps such as Airbnb, Vrbo, etc., that enable terminal entities to list rental properties. These apps are centered on user-generated listings and thus may be described as a “terminal entity-initiated posting platform” or a “self-publishing marketplace”. It also remains a common practice for a terminal entity to manually monitor the internet to learn of an upcoming event or seasonality change that may indicate a period of high rental demand. If a terminal entity is not using a rental management system to manage a rentable unit, they are forced to manually perform all steps involved in the rental process. Even if they use a rental management system, the terminal entity must proactively interact with the rental management system to gain the benefit of any analytical solutions that the rental management system might offer. There is a unique need for a technical solution that functions independently of any manual activity of a terminal entity, and that can systematically inform a terminal entity of rental opportunities in near-real-time, such as uniquely lucrative windows within periods of variable demand, and that generates a rental price prediction based on analysis of historical rental pricing data and/or market trends. A solution of this nature would be intractable without a systematic and computer-based implementation. Accordingly, there is a latent technical need for systems that can automatically provide this capability.

Example implementations described herein provide a technical solution to this technical problem. Moreover, example implementations overcome the challenges that arise from manually monitoring for rental opportunities, while also preventing missed opportunities or financial losses incurred by mispriced rental listings. Example embodiments described herein use a rental optimization system that, in response to the detection of a trigger event (e.g., an upcoming event or seasonality change), is configured to inform a terminal entity of an opportunity to list their rentable unit for rent, thereby ensuring that they do not lose out on a profitable opportunity. Further, example embodiments deploy a predictive analytics machine learning model to generate a rental price prediction for a rentable unit that maximizes the financial benefit for a terminal entity.

Accordingly, the present disclosure sets forth systems, methods, and apparatuses to optimize the returns on renting real estate. Receiving a rental valuation of a rentable unit based on the analysis of historical rental pricing data provides a terminal entity with greater confidence in the listed rental price being of fair market value, particularly during periods of fluctuating rental demand. Example embodiments thus provide real-world benefits over legacy manual approaches. Moreover, example embodiments may inform a terminal entity of the rental potential of their rentable unit during periods of fluctuating rental demand, which is beyond the capability of manual monitoring or existing rental management systems.

Beyond just technical benefits, there are many real-world advantages of these embodiments and the other embodiments described herein. For example, a terminal entity that manages multiple properties may use example embodiments to evaluate how certain trigger event attributes impact the value of a rentable unit. This information may also aid a terminal entity in assessing and comparing the profitability between selling a rentable unit and renting the rentable unit. Furthermore, the implementation of a rental optimization system that does not rely on a terminal entity-initiated listing, provides a fair chance to any terminal entity that is unaware about such opportunities to earn income and/or make profit from their rentable unit. Example embodiments for rental optimization of real estate thus enable involvement of more terminal entities in the rental market, thereby building a stronger and more equitable rental community.

In one example embodiment, a method is provided for rental optimization of real estate. The method includes detecting, by an event monitoring engine, an occurrence of a trigger event, wherein the trigger event is associated with a trigger event attribute set, wherein the trigger event attribute set includes a trigger event type and one or more trigger event type attributes. The method further includes defining, by the event monitoring engine and based on the trigger event attribute set, an area of interest. The method further includes identifying, by a prospect engine, a rentable unit within the area of interest that corresponds to a trigger event type attribute from the one or more trigger event type attributes. The method further includes generating, by the prospect engine and based on the trigger event attribute set, a rental price prediction for the rentable unit, and in an instance in which the rental price prediction satisfies a predefined rental price threshold, the method further includes generating, by the prospect engine and based on the rental price prediction, a personalized rental recommendation for the rentable unit, and outputting, by communications hardware, a rental prompt based on the personalized rental recommendation.

In another example embodiment, an apparatus is provided for rental optimization of real estate. The apparatus includes an event monitoring engine configured to detect an occurrence of a trigger event, wherein the trigger event is associated with a trigger event attribute set, wherein the trigger event attribute set includes a trigger event type and one or more trigger event type attributes. The event monitoring engine is further configured to define, based on the trigger event attribute set, an area of interest. The apparatus further includes a prospect engine that is configured to identify a rentable unit within the area of interest that corresponds to a trigger event type attribute from the one or more trigger event type attributes. The prospect engine is further configured to generate, based on the trigger event attribute set, a rental price prediction for the rentable unit, and in an instance in which the rental price prediction satisfies a predefined rental price threshold, the prospect engine is further configured to generate, based on the rental price prediction, a personalized rental recommendation for the rentable unit. The apparatus further includes communications hardware configured to output a rental prompt based on the personalized rental recommendation.

In another example embodiment, a computer program product is provided for rental optimization of real estate. The computer program product includes at least one non-transitory computer readable storage medium storing software instructions that, when executed, cause an apparatus to detect an occurrence of a trigger event, wherein the trigger event is associated with a trigger event attribute set, wherein the trigger event attribute set includes a trigger event type and one or more trigger event type attributes. The at least one non-transitory computer-readable storage medium storing the software instructions that, when executed, further cause an apparatus to define, based on the trigger event attribute set, an area of interest. The at least one non-transitory computer-readable storage medium storing the software instructions that, when executed, further cause an apparatus to identify a rentable unit within the area of interest that corresponds to a trigger event type attribute from the one or more trigger event type attributes. The at least one non-transitory computer-readable storage medium storing the software instructions that, when executed, further cause an apparatus to generate, based on the trigger event attribute set, a rental price prediction for the rentable unit, and in an instance in which the rental price prediction satisfies a predefined rental price threshold, The at least one non-transitory computer-readable storage medium storing the software instructions that, when executed, further causes an apparatus to generate, based on the rental price prediction, a personalized rental recommendation for the rentable unit, and output a rental prompt based on the personalized rental recommendation.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for rental optimization of real estate, in accordance with some example embodiments described herein.

FIG. 2 illustrates a schematic block diagram of example circuitry embodying a device that may perform various operations in accordance with some example embodiments described herein.

FIG. 3 illustrates an example flowchart for rental optimization of real estate, in accordance with some example embodiments described herein.

FIG. 4 illustrates an example flowchart for defining an area of interest based on a trigger event, in accordance with some example embodiments described herein.

FIG. 5 illustrates an example flowchart for training a predictive analytics machine learning model based on aggregated historical rental pricing data, in accordance with some example embodiments described herein.

FIG. 6 illustrates an example flowchart for generating a rental price prediction for a rentable unit, in accordance with some example embodiments described herein.

FIG. 7 illustrates an example flowchart for outputting a rental prompt to a terminal entity based on a personalized rental recommendation, in accordance with some example embodiments described herein.

FIG. 8 illustrates a schematic block diagram of an interest score calculation framework.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “set of data environments” may refer to any collection of distinct spaces or contexts where data may be stored, processed, and managed. In some embodiments, the set of data environments may be monitored for (i) detecting an occurrence of a trigger event, (ii) for aggregating historical rental pricing data, and/or the like.

The term “trigger event data” may refer to any information about a detected trigger event that is extracted from a set of data environments and categorized into attributes to generate a trigger event attribute set associated with the extracted trigger event data.

The term “underlying geography” may refer to the geographical characteristics of a location, area, space, and/or the like. In some embodiments, the underlying geography encompasses the physical, natural, spatial, and/or digital attributes that define a particular space. In some embodiments, the underlying geography may focus on features of landscape, environment, topography that shape the characteristics, resources, and potential uses of a particular location, area, space, and/or the like.

The term “set of perimeter points” may refer to a collection of specific data points that define the outer boundary or edge of a particular location, area, space, and/or the like. In some embodiments, the set of perimeter points are generated in a way, that, when connected, they outline the boundary of a particular location, area, space, and/or the like for the detected trigger event.

The term “predefined threshold of distance” may refer to a predetermined or pre-established value that sets a limit for how apart the set of perimeter points may be from the location of the trigger event. In some embodiments, the predefined threshold of distance is defined based on the context and requirements of a particular trigger event and the associated trigger event data.

The term “virtual boundary” may refer to an imaginary or digital demarcation that defines a particular location, area space, and/or the like in a virtual or digital environment. In some embodiments, the virtual boundary is a conceptual or computational construct used to establish limits, rules, or interactions within the virtual space.

The term “predictive analytics machine learning model” may refer to a data construct that is configured to describe parameters, hyper-parameters, and/or stored operations of a machine learning model to (i) process one or more features of historical rental pricing data, (ii) to train one or more predictive analytics machine learning models, and/or (iii) generate a rental price prediction for a rentable unit. In some embodiments, the predictive analytics machine learning model may use one or combinations of the following, and/or the like to (i) process one or more features of historical rental pricing data, (ii) to train one or more predictive analytics machine learning models, and/or (iii) generate a rental price prediction for a rentable unit: (i) convolutional neural network (CNN), (ii) random forest, (iii) recurrent neural networks (RNN), (iv) long short-term memory (LSTM) networks, (v) k-nearest neighbors (KNN), (vi) time series models, etc.

The term “interest score calculation framework” may describe a system architecture which may be used to calculate the interest score of a terminal entity. The interest score of a terminal entity may be indicative of the likelihood of a terminal entity listing their rentable unit for rent. In some embodiments, the interest score calculation framework may use terminal entity data and categorize said terminal entity data into different data types to calculate an individual score for each data type. In some embodiments, the calculated score for each data type may be indicative of the influence each data type carries towards determining the overall interest score. In some embodiments, the overall interest score may be determined by calculating the average across the individual scores calculated for each data type.

### System Architecture

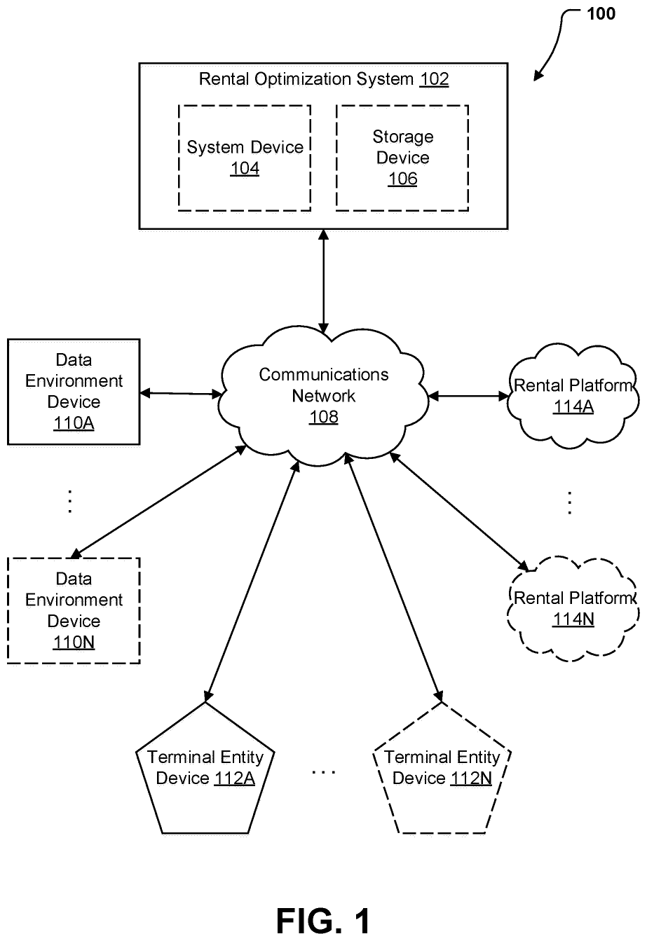

Example embodiments described herein may be implemented using any of a variety of computing devices or servers. To this end, FIG. 1 illustrates an example environment 100 within which various embodiments may operate. As illustrated, a rental optimization system 102 may include a system device 104 in communication with a storage device 106. Although system device 104 and storage device 106 are described in singular form, some embodiments may utilize more than one system device 104, more than one storage device 106, and/or the like. Some embodiments of the rental optimization system 102 may not require a system device 104 and/or storage device 106 at all. Whatever the implementation, the rental optimization system 102, and its constituent system device 104 and/or storage device 106 may receive and/or transmit information via communications network 108 (e.g., the Internet) with any number of other devices, such as one or more of data environment devices 110A-110N and/or terminal entity devices 112A-112N. Furthermore, the communications network 108 may communicate with one or more of rental platforms 114A-114N.

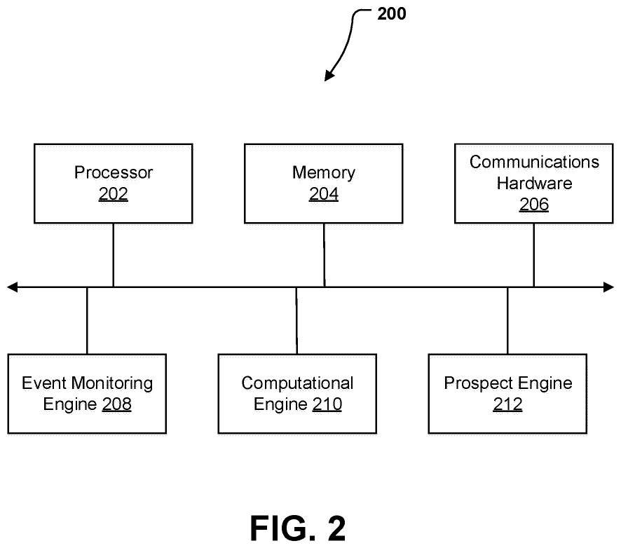

In some embodiments, the rental optimization system 102 further includes a system device 104 that may be implemented as one or more computing devices or servers, which may be composed of a series of components. These components of system device 104 may be physically proximate to the other components of the rental optimization system 102 while other components are not. The system device 104 may receive, process, generate, and transmit data, signals, and electronic information to facilitate the operations of the rental optimization system 102. Particular components of the rental optimization system 102 are described in greater detail below with reference to apparatus 200 in connection with FIG. 2.

In some embodiments, the rental optimization system 102 further includes a storage device 106 that comprises a distinct component from other components of the rental optimization system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the rental optimization system 102. Storage device 106 may store information relied upon during operation of the rental optimization system 102, such as various historical rental pricing data that may be used by the rental optimization system 102, data and documents to be analyzed using the rental optimization system 102, or the like. In addition, storage device 106 may store control signals, device characteristics, and access credentials enabling interaction between the rental optimization system 102 and one or more of the data environment devices 110A-110N, terminal entity devices 112A-112N, or rental platforms 114A-114N.

The data environment devices 110A-110N, terminal entity devices 112A-112N, and rental platforms 114A-114N may be embodied by any computing devices known in the art, such as computers, laptops, servers, etc. The one or more data environment devices 110A-110N, terminal entity devices 112A-112N, and the one or more rental platforms 114A-114N need not themselves be independent devices, but may be peripheral devices communicatively coupled to other computing devices. In some embodiments, the one or more data environment devices 110A-110N may each be associated with a particular entity. For example, data environment device 110A may be associated with Ticketmaster and data environment device 110B may be associated with Eventbrite. Similarly, in some embodiments, the one or more terminal entity device 112A may be associated with an app on a consumer mobile phone, and terminal entity device 112N may be associated with an internal server of a rental company. Likewise, rental platform 114A-114N may each be associated with a particular rental platform. For example, rental platform 114A may be associated with Airbnb and rental platform 114N may be associated with Vrbo.

### Example Implementing Apparatuses

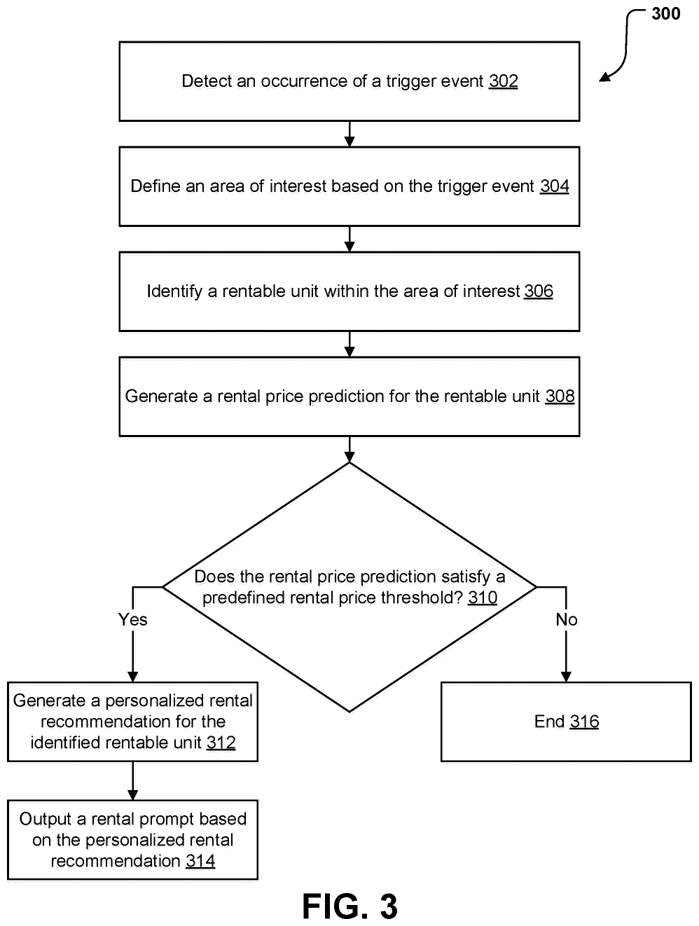

The rental optimization system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, event monitoring engine 208, computational engine 210, and prospect engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, and multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

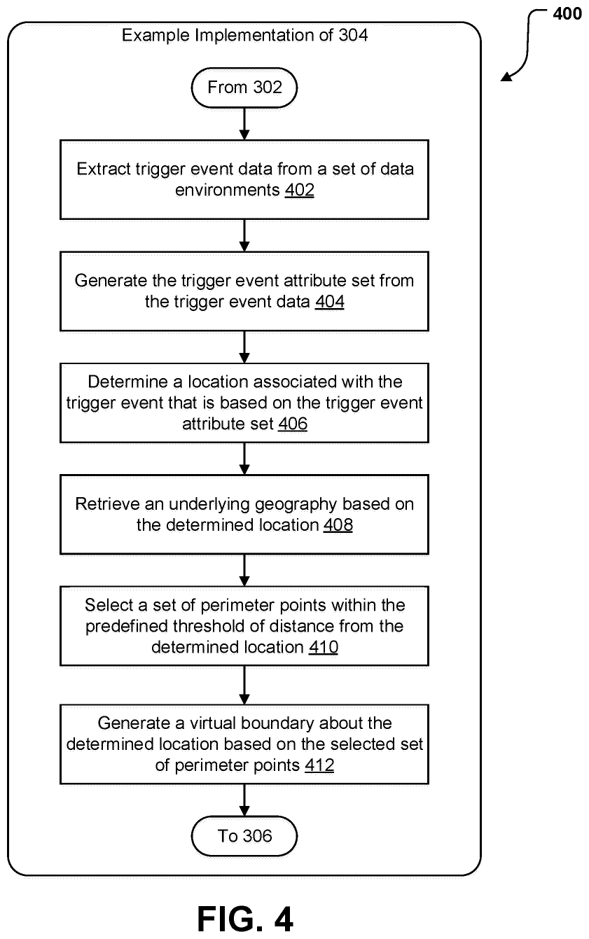

In addition, the apparatus 200 further comprises an event monitoring engine 208 that detects an occurrence of a trigger event. In some embodiments, the event monitoring engine 208 may be configured to surveil a set of data environments for a trigger event, extract trigger event data from the set of data environments, and generate a trigger event attribute set from the trigger event data. Furthermore, the event monitoring engine 208 defines an area of interest and may be configured to determine location data associated with the trigger event, retrieve an underlying geography of the location data, select a set of perimeter points within a predefined threshold of distance from the location of the trigger event, and generate a virtual boundary about the determined location. The event monitoring engine 208 may utilize processor 202, memory 204, or any other hardware component included in the apparatus 200 to perform these operations, as described in connection with FIGS. 3-4 below. The event monitoring 208 may further utilize communications hardware 206 to gather data from a variety of sources (e.g., data environment device 110A through data environment device 110N or storage device 106, as shown in FIG. 1), and/or exchange data with a user, and in some embodiments, may utilize processor 202 and/or memory 204 to detect an occurrence of a trigger event, and define an area of interest based on the detected trigger event.

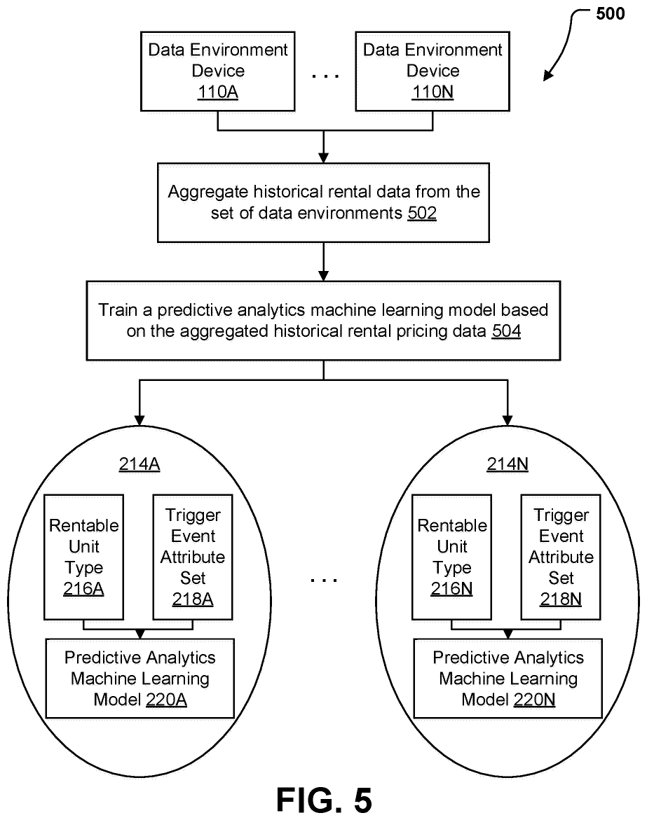

In addition, the apparatus 200 may further comprise a computational engine 210 that aggregates historical rental pricing data and trains one or more predictive analytics machine learning models. The computational engine 210 may utilize processor 202, memory 204, or any other hardware component included in the apparatus 200 to perform these operations, as described in connection with FIG. 5 below. The computational engine 210 may further utilize communications hardware 206 to gather data from a variety of sources (e.g., data environment devices 110A-110N or storage device 106 as shown in FIG. 1), and/or exchange data with a user.

Furthermore, the apparatus 200 further comprises a prospect engine 212 that identifies a rentable unit within the area of interest, generates a rental price prediction and a personalized rental recommendation for the rentable unit based on the rental price prediction generated. The prospect engine 212 may utilize processor 202, memory 204, or any other hardware component included in the apparatus 200 to perform these operations, as described in connection with FIG. 3 and FIGS. 6-7 below. The prospect engine 212 may further utilize communications hardware 206 to gather data from a variety of sources (e.g., data environment devices 106A-106N, terminal entity devices 112A-112N, and/or rental platforms 114A-114N as shown in FIG. 1), and/or exchange data with a user.

Although components 202-212 are described in part using functional language, it will be understood that the particular implementations necessarily include the use of particular hardware. It should also be understood that certain of these components 202-212 may include similar or common hardware. For example, the event monitoring engine 208, computational engine 210, and prospect engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the event monitoring engine 208, computational engine 210, and prospect engine 212 may leverage processor 202, memory 204, or communications hardware 206 as described above, it will be understood that any of event monitoring engine 208, computational engine 210, and prospect engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that event monitoring engine 208, computational engine 210, and prospect engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts and schematic block diagrams.

### Example Operations

Turning to FIGS. 3-7, example flowcharts are illustrated that contain example operations implemented by example embodiments described herein. The operations illustrated in FIGS. 3-7 may, for example, be performed by the rental optimization system 102 shown and described in connection with at least FIG. 1, which may in turn be embodied by an apparatus 200, which is shown and described in connection with at least FIG. 2. To perform the operations described below, the apparatus 200 may utilize one or more of processor 202, memory 204, communications hardware 206, event monitoring engine 208, computational engine 210, prospect engine 212, and/or any combination thereof. It will be understood that user interaction with the rental optimization system 102 may occur directly via communications hardware 206, or may instead be facilitated by a separate terminal entity device 110A-110N, as shown in FIG. 1, and which may have similar or equivalent physical componentry facilitating such user interaction.

Turning first to FIG. 3, a procedure 300 illustrates example operations for the rental optimization of real estate. As shown by operation 302, the apparatus 200 includes means, such as memory 204, communications hardware 206, event monitoring engine 208, or the like, for detecting an occurrence of a trigger event. The event monitoring engine 208 may detect an occurrence of a trigger event by leveraging communications hardware 206 to surveil a set of data environments. In various examples, the particular data environment(s) that are monitored may be based on the particular use case. For instance, in some examples, the data environment may include a live event environment, such as a ticketing platform (e.g., Ticketmaster, Eventbrite, etc.). In another example, the data environment may include news and/or media sources, such as RSS feeds and news websites. In another example, the data environment could include a source of weather information. More generally, in some examples, the data environment may be the Internet, or any combination of the foregoing. The event monitoring engine 208 may additionally, or alternatively, identify occurrence of the trigger event from querying memory 204 for data indicative of a trigger event (which, for instance, may have been previously retrieved via communications hardware 206 or a separate component and stored by the memory 204). A trigger event may correspond to a seasonality change, scheduling of an organized event, and/or the like, that is associated with a trigger event attribute set. A trigger event attribute set may be categorized into one or more attributes associated with the trigger event including trigger event type, where the trigger event type may comprise one or more trigger event type attributes such as a required rentable unit type. In example embodiments, the trigger event attribute set may comprise other attributes such as general location, address, date(s), time(s), target cohort, and/or the like.

For example, the scheduling of a concert may qualify as a trigger event, and the corresponding trigger event attribute set may comprise the following attributes: (i) trigger event type: “concert” where a trigger event type attribute may be “rentable unit type-residential and commercial”, (ii) location: “Charlotte-North Carolina”, (iii) address: “Bank of America Stadium”, (iv) date: “Jul. 27, 2024”, (v) target cohort: “young adults”, etc. As another example, a seasonality change from spring to summer may qualify as a trigger event. The corresponding trigger event attribute set may comprise the following attributes: (i) trigger event type: “seasonality” where the trigger event type attribute may be “rentable unit type-residential”, (ii) location: “Downtown Toronto-Ontario”, (iii) dates: “Jul. 1-Aug. 31, 2024”, (iv) target cohort: families with young children”, etc.

As shown by operation 304, the apparatus 200 includes means, such as event monitoring engine 208, or the like, for defining an area of interest based on the trigger event. The area of interest comprises a zone (e.g., geographic delineation) encompassing the location of the detected trigger event and a relevant area(s) about the location of the detected trigger event. The event monitoring engine 208 may determine a relevant area based on criteria such as proximity to the location of the trigger event, zoning types (e.g., residential, commercial, etc.), nearby transportation hubs, and/or the like. In some embodiments, operation 304 may include the steps described below in connection with the flowchart illustrated in FIG. 4.

Turning now to FIG. 4, a procedure 400 illustrates example operations for defining an area of interest. As shown by operation 402, the apparatus 200 includes means, such as communications hardware 206, event monitoring engine 208, or the like, for defining an area of interest based on the trigger event. Upon detecting an occurrence of a trigger event, the event monitoring engine 208 may extract trigger event data from the set of data environments to generate a trigger event attribute set as described above. In some embodiments, the event monitoring engine 208 may extract trigger event data by using communications hardware 206.

As shown by operation 404, the apparatus 200 includes means, such as processor 202, memory 204, event monitoring engine 208, or the like, for generating the trigger event attribute set from the trigger event data. Trigger event data may have a trigger event data type, which may be numerical, text, images, video, audio, sensor data, or any combination thereof, and/or the like. The event monitoring engine 208 may be provided with domain-specific knowledge to determine which features may be relevant for generating a rental price prediction for a particular trigger event attribute set. To generate the trigger event attribute set from the trigger event data, and depending on the trigger event data type, the event monitoring engine 208 may perform various operations such as (i) preprocessing the trigger event data (e.g., data cleaning, imputation, outlier detection, etc.) using processor 202, (ii) extracting and transforming attributes from the preprocessed data (e.g., computing statistics, TF-IDF, CNNs, etc.) for integration with a predictive analytics machine learning model, (iii) selecting relevant transformed attributes that may contribute the most to the prediction power of a predictive analytics machine learning model, (iv) engineering new composite attributes based on the selected set of the most relevant transformed attributes that represent the underlying pattern in the trigger event data (e.g., aggregating attributes, creating time-based attributes, etc.), (v) encoding the selected attributes into a format that a predictive analytics machine learning model can interpret, (vi) normalizing the encoded attributes (e.g., Z-score normalization, min-max scaling, etc.), or any combination thereof, and/or the like. The generated trigger event attribute set may be stored in memory 204 or other storage and retrieved for use in downstream operations.

As shown by operation 406, the apparatus 200 includes means, such as memory 204, event monitoring engine 208, or the like, for determining a location associated with the trigger event. From the trigger event attribute set, the event monitoring engine 208 may extract an address, coordinates, a landmark, a geographical reference, and/or other data that provides information about the location of the trigger event. The trigger event location data may comprise textual, visual, numerical data, or any combination thereof and/or the like. In some embodiments, the event monitoring engine 208 may perform geospatial analysis (e.g., spatial clustering, spatial interpolation, spatial analysis, etc.) to determine the likely location of a trigger event based on the trigger event location data extracted from the trigger event attribute set. The event monitoring engine 208 may also parse an extracted address by breaking it down into its individual components (e.g., street name, city, state, postal code, country, etc.) and compile this into a unified dataset with other trigger event location data, associating said dataset with the particular trigger event. The trigger event location data may be stored in memory 204 or other storage and retrieved for use in downstream operations.

As shown by operation 408, the apparatus 200 includes means, such as memory 204, communications hardware 206, event monitoring engine 208, or the like, for retrieving an underlying geography of the determined location. In some embodiments, the event monitoring engine 208 may retrieve underlying geography of the determined location in conjunction with communications hardware 206. The event monitoring engine 208 may process textual data into geographical coordinates (latitude and longitude) through geocoding services or APIs such as Google Maps API, Bing Maps, etc. If the trigger event location data primarily comprises geographic coordinates, the event monitoring engine 208 may use reverse geocoding to convert the geographic coordinates into an address or recognizable location. In some embodiments, where the determined location is ambiguous, the event monitoring engine 208 may analyze nearby contextual features (e.g., proximity to the ocean, road networks, building densities, land use, etc.) to disambiguate the location, and/or use additional data sources, such as street-level imagery or satellite images to visually inspect the area around geographical coordinates for recognizable location features. The retrieved underlying geography may be stored in memory 204 or other storage and retrieved for use in downstream operations.

As shown by operation 410, the apparatus 200 includes means, such as, memory 204, event monitoring engine 208, or the like, for selecting a set of perimeter points within a predefined threshold of distance from the determined location. The event monitoring engine 208 may define a threshold of distance for a particular trigger event by (i) considering the areas surrounding the determined location with highest rental demand during a prior trigger event, (ii) forecasted influx of people arriving at the determined location for the trigger event, (iii) volume of the determined location, (iv) adhering to one or more predefined parameters, or any combination thereof, and/or the like. The selected set of perimeter points may be stored in memory 204 or other storage and retrieved for use in downstream operations.

As shown by operation 412, the apparatus 200 includes means, such as, memory 204, event monitoring engine 208, or the like, for generating a virtual boundary about the determined location based on the selected set of perimeter points. The event monitoring engine 208 may connect the selected set of perimeter points to generate a virtual boundary, wherein the selected set of perimeter points may refer to a set of latitude and longitude pairs that create a virtual geometric boundary when connected. By way of continued example, in an instance in which a concert takes place at the Bank of America Stadium in Charlotte-North Carolina, the event monitoring engine 208 may generate a boundary about the Bank of America Stadium, thereby encompassing the neighborhoods of Uptown Charlotte, 10 miles about the determined location. Alternatively, by way of continued example, for the trigger event associated with a seasonality change, the event monitoring engine 208 may use a map service such as Google Maps to identify that Downtown Toronto is by the coast of Lake Ontario, and generate a virtual boundary that encompasses the city up to 10 miles off the coast of Lake Ontario. The generated virtual boundary may be stored in memory 204 or other storage and retrieved for use in downstream operations. Following generation of the virtual boundary, the procedure returns to operation 306.

As shown by operation 306, the apparatus 200 includes means, such as memory 204, prospect engine 212, or the like, for identifying a rentable unit within the area of interest. Based on one or more attributes of the generated trigger event attribute set and the area of interest, prospect engine 212 may identify one or more relevant rentable units. A rentable unit may refer to a space within a multi-unit building or a standalone structure that is available for lease to tenants, and may serve as an independent or functional area that caters to a variety of purposes. In some examples, this may include residential properties. In other examples, this may include commercial or industrial properties. In yet other examples, this may include multi-purpose properties (e.g., residential, commercial, and industrial, and etc.). The rentable unit may include its own private entrance, utility connections (e.g., electricity, water, gas), and amenities such as laundry facilities, parking spaces, access to shared amenities, and/or the like. The identified rentable unit may be stored in memory 204 or other storage and retrieved for use in downstream operations.

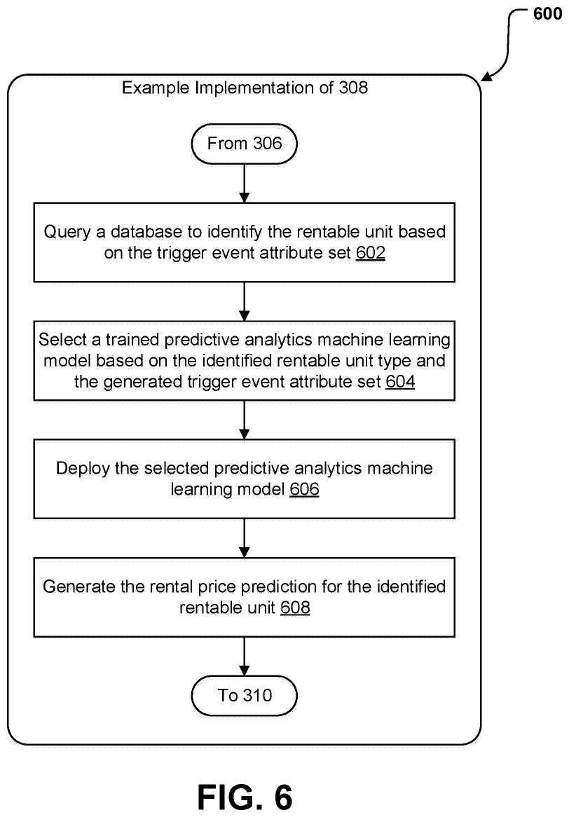

As shown by operation 308, the apparatus 200 includes means, such as memory 204, prospect engine 212, or the like, for generating a rental price prediction for the identified rentable unit. A rental price prediction is the estimated price that the identified rentable unit is expected to command if listed for rent for a defined period of time (e.g., one day, one week, one month, one year, etc.). In some examples, the period of time may correspond to the duration of the event. For instance, if the event corresponds to a weekend music festival, e.g., with a duration of a Friday, Saturday, and Sunday, the period of time may correspond to three days, including the Friday to Sunday period. In some embodiments, operation 308 may be performed in reference to the operations described by FIG. 6.

Turning now to FIG. 6, a procedure 600 illustrates detailed operations for generating a rental price prediction for the identified rentable unit, wherein the apparatus 200 includes means, such as, memory 204, prospect engine 212, or the like. As shown by operation 602, the prospect engine 212 may query memory 204 to retrieve information from the generated trigger event attribute set, and query a database to identify rentable units corresponding with one or more attributes from the trigger event attribute set. Such databases are repositories of data that may store structured, semi-structured, and unstructured data of variable dimensionality. Data of variable dimensionality may refer to different records or entries in a database that may have a varying number of attributes or fields, resulting in varying levels of data complexity. By way of continued example, in an instance in which multiple artists are scheduled to perform at a concert in Charlotte, North Carolina, the performing artists may require a commercial auditorium or stage space for rehearsal purposes. For this instance, there may be a need for commercial rentable units, so, in general, an appropriate database may store data for commercial rentable units with features such as acoustic design (e.g., sound insulation, diffusers, absorbers), stage and performance area, lighting and sound equipment, number of green rooms and restrooms backstage, rehearsal rooms, storage and equipment space, seating and audience area, ventilation and climate control, accessibility, recording facilities, catering facilities, parking and transportation, security and safety measures, aesthetics and ambience, and/or the like. Of course, there may be a need for residential rentable units as well (recognizing that a non-local crowd may be attending the same concert). An appropriate database may therefore also store data for residential rentable units with features such as venue proximity, transportation accessibility, security, nearby amenities, appropriate sleeping arrangements, number of bedrooms, number of washrooms, kitchen facilities, internet connectivity, laundry facilities, entertainment options, parking, pet-friendly options, responsive host, affordability, flexibility for groups, and/or the like.

As shown by operation 604, the apparatus 200 includes means, such as memory 204, prospect engine 212, or the like, for selecting a trained predictive analytics machine learning model from the set of trained predictive analytics machine learning models stored in memory 204 or other storage, where each trained predictive analytics machine learning model 214A-214N corresponds to a rentable unit type 216A-216N uniquely associated with a trigger event attribute set 218A-218N that may be used to generate a plurality of predictive analytics machine learning models 220A-220N. The prospect engine 212 may utilize one or more of the following approaches, and/or the like to select an appropriate predictive analytics machine learning model trained for a particular scenario: (i) rule-based selection that use a set of rules or conditions to guide the software in selecting the appropriate model based on specific input parameters (e.g., a model is selected based on certain features or characteristics matching predefined criteria), (ii) ensemble methods where multiple models are combined to yield the best model for a particular scenario, (iii) establishing threshold or confidence levels for each model's performance and selecting the model that meets or exceeds the threshold, and/or the like. One or more of the predictive analytics machine learning models may be trained as demonstrated in FIG. 5.

Turning now to FIG. 5, a procedure 500 illustrates example operations for training one or more predictive analytics machine learning models. As described below, the apparatus 200 trains the one or more predictive analytics machine learning models using aggregated historical rental pricing data. The historical rental pricing data may comprise various features of a rentable unit that bear an influence on the rental value of the rentable unit. Example features may be (i) date, time, price of prior rental transactions, (ii) the geographical area where a rental property is located (e.g., city, neighborhood, specific address), (iii) property type, (iv) size and layout (e.g., number of rooms or washrooms), (v) amenities (e.g., furnishings, appliances, gym, swimming pool), (vi) condition (e.g., renovations, upgrades, maintenance), (vii) market trends (e.g., housing market fluctuations, supply and demand dynamics), (viii) neighborhood factors (e.g., proximity to public transportation, schools, shopping centers, parks, etc.), target tenant type (e.g., families, students, professionals, tourists, etc.) (ix) lease terms (e.g., length of the lease, rent payment frequency, special terms or conditions), (x) external influences (e.g., changes in local regulations, tax policies, or economic events), (xi) vacancy rates, (xii) inflation and cost of living, (xiii) rental duration data that contributes to the rental price (e.g., determining whether the rental price was calculated on a per day, per hour, per month, or per year basis), and/or the like. In various examples, the rental price may be calculated based on the duration data for a particular use case. For instance, the rental price for residential properties may follow a per day or per month rate, whereas the rental price for commercial or industrial spaces may follow a per hour or per event rate.

Turning to operation 502, the apparatus 200 includes means, such as memory 204, communications hardware 206, computational engine 210, or the like for aggregating historical rental pricing data from a set of data environments 106A-106N. The computational engine 210 may aggregate this historical rental pricing data from memory 204 or other storage, or may be retrieve it via communications hardware 206 from the set of data environments 106A-106N (e.g., internet, remote servers) that aggregate such historical rental pricing data. The set of data environments 106A-106N used herein may or may not be the same set of data environments as used by the event monitoring engine 208 in FIGS. 3-4. Aggregation of the historical rental pricing data may further involve one or more preprocessing steps prior to using that data for training. For instance, the computational engine 210 may interpret and structure the historical rental pricing data to prepare the data as input for a machine learning model by formatting, normalizing, cleaning, infilling, or performing other operations to prepare valid machine learning training data. The computational engine 210 may also partition the historical rental pricing data into one or more of the categories of training data (e.g., a training data set, testing data set, and validation data set), and may then. The computational engine 210 may also initially define hyperparameters for each of the one or more machine learning models to be trained.

As shown by operation 504, the apparatus 200 includes means, such as memory 204, computational engine 210, or the like for training one or more predictive analytics machine learning models 214A-214N. The performance of the predictive analytics machine learning models may be evaluated using validation metrics or techniques and may be serialized in a format that can be easily loaded into a software's codebase for use. Such serialization may involve using a machine learning framework, library, or API that supports the model's deployment. A particular predictive analytics machine learning model 214A may be trained for making rental predictions for a rentable unit type 216A (e.g., condominium) that is uniquely associated with a trigger event attribute set 218A (e.g., concert in Charlotte-North Carolina). These trained predictive analytics machine learning models may be regularly updated with new data or retrained as needed and may be stored in memory 204, a remote server, a cloud service, or other storage for later use.

Returning to FIG. 6, as shown by operation 606, the apparatus 200 includes means, such as, prospect engine 212, or the like, for deploying the selected predictive analytics machine learning model. The prospect engine 212 may package the selected predictive analytics machine learning model in a format suitable for deployment, and ensure that it is configured to behave as expected in a target deployment environment. The target deployment environment may be physical servers, virtual machines, cloud instances, or containers.

As shown by operation 608, the apparatus 200 includes means, such as, memory 204, communications hardware 206, prospect engine 212, or the like, for generating the rental price prediction for the identified rentable unit. An API endpoint, and/or the like may be created prior to deployment and may be coupled with the selected predictive analytics machine learning model so that it may receive input data and generate predictions in return. APIs, and/or the like operate as an interactive gateway for the model, allowing the model to be updated or replaced without affecting the overall software architecture, and enabling the model to be used by multiple parts of the software or external applications, thereby allowing for modularity and reusability.

The deployment process may begin when an initiation request is received by the deployed model through communications hardware 206. The generated trigger event attribute set and identified rentable unit type may be retrieved from memory 204, or other storage, and operate as the primary input data for generating predictions. The data associated with the trigger event attribute set and identified rentable unit type may be formatted or preprocessed to include the relevant features the model expects as input. In an instance in which feature transformations were applied during model training (e.g., scaling, normalization), the input features may need to undergo the same transformations before being fed into the model. This transformed input data is passed through the deployed model, upon which the deployed machine learning model may use the learned patterns and relationships to generate a rental price prediction based on the input features and trained algorithms. As an optional deployment feature, additional steps such as formatting, performing additional calculations, and/or the like, may be applied to the generated rental price prediction for post-processing purposes. The generated rental price prediction may be returned as part of the response to the initial initiation request in various formats such as plain text, and/or the like.

Returning to FIG. 3, as shown by operation 310, the apparatus 200 includes means, such as, prospect engine 212, or the like, for determining whether the rental price prediction satisfies a predefined rental price threshold. The predefined rental price threshold may correspond to a predefined rental price threshold value which, when exceeded, identifies the rental price prediction for further action (i.e., the rental price prediction must satisfy the predefined rental price threshold to render it worth flagging for further action). In some embodiments, the predefined rental price threshold may correspond to a predefined rental price threshold value at which the terminal entity would net a profit (i.e., the rental price prediction is greater than the cost/investment). In another example, the predefined rental price threshold may correspond to a value for a minimum percentage profit (e.g., minimum of five percent profit). In another example, the predefined rental price threshold may correspond to a value to minimize a loss (e.g., no more than five percent loss). If the rental price prediction satisfies the predefined rental price threshold, the procedure advances to operation 312. Otherwise, the procedure advances to operation 316. In some embodiments, no predefined rental price threshold may be used, such that the procedure advances directly from operation 308 to operation 312 and omits performance of operation 310 entirely.

In embodiments where operation 310 is reached, the value of the predefined rental price threshold may be set by one or more authorized users (e.g., a user associated with the terminal entity in question). For example, a predefined rental price threshold may require that the rental price prediction is greater than or equal to a set value, such as five hundred dollars. As such, prospect engine 212 may compare the rental price prediction to the predefined rental price threshold, and in an instance in which the rental price prediction meets or exceeds the set value (e.g., corresponds to a value of five hundred dollars or more), the prospect engine 212 may determine the rental price prediction satisfies the predefined rental price threshold. Furthermore, the predefined rental price threshold may be a prediction confidence threshold, and/or the like that represents the minimum level of confidence or certainty required for the predictive analytics machine learning model to generate a personalized rental recommendation for the identified rentable unit.

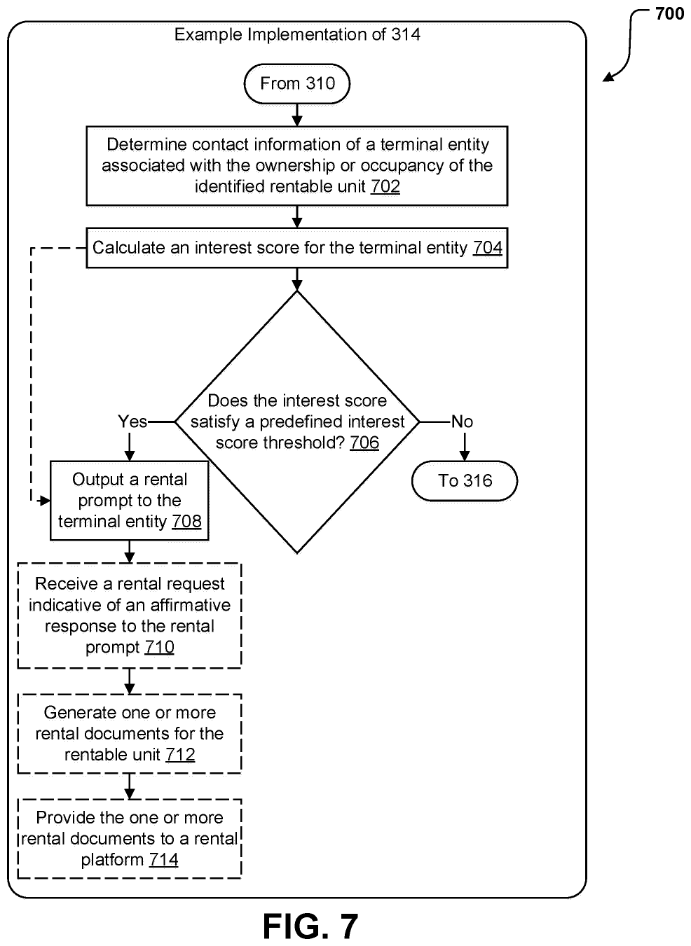

As shown by operation 312, the apparatus 200 includes means, such as communications hardware 206, prospect engine 212, or the like, for generating a personalized rental recommendation for the identified rentable unit. In regard to listing the identified rentable unit for rent, a personalized rental recommendation is a suggestion that is specifically curated to match the preferences and/or needs of a terminal entity. The personalized rental recommendation may take into consideration a financial goal of a terminal entity. In some embodiments, operation 312 may be performed in accordance with the operations described by FIG. 7.

As shown by operation 314, the apparatus 200 includes means, such as, communications hardware 206, prospect engine 212, or the like, for T outputting a rental prompt to the terminal entity based on the personalized rental recommendation. In some embodiments, operation 314 may be performed in accordance with the operations described by FIG. 7.

As shown by operation 316, the apparatus 200 includes means, such as communications hardware 206, prospect engine 212, or the like, for demonstrating that in an instance in which the generated rental price prediction does not satisfy the predefined rental price threshold, no personalized rental recommendation may be generated or outputted to a terminal entity via communications hardware 206. A predefined interest score threshold may be a threshold that determines the minimum predicted level of interest for renting the identified rentable unit that is required before the apparatus 200 will generate a personalized rental recommendation. If the terminal entity satisfies the predefined interest score threshold, a rental prompt may be outputted based on the personalized rental recommendation. The rental prompt is a statement, provided to the terminal entity that serves as the output of the predictive analytics machine learning model. By way of continued example, a rental prompt may resemble the following: “Taylor Swift is in town for a concert on Jul. 27, 2024 and you can earn $2000 by renting your property on 423 Eastchester Drive. Press ‘continue’ to be directed to a rental marketplace and meet 50% of your annual passive income goal.”

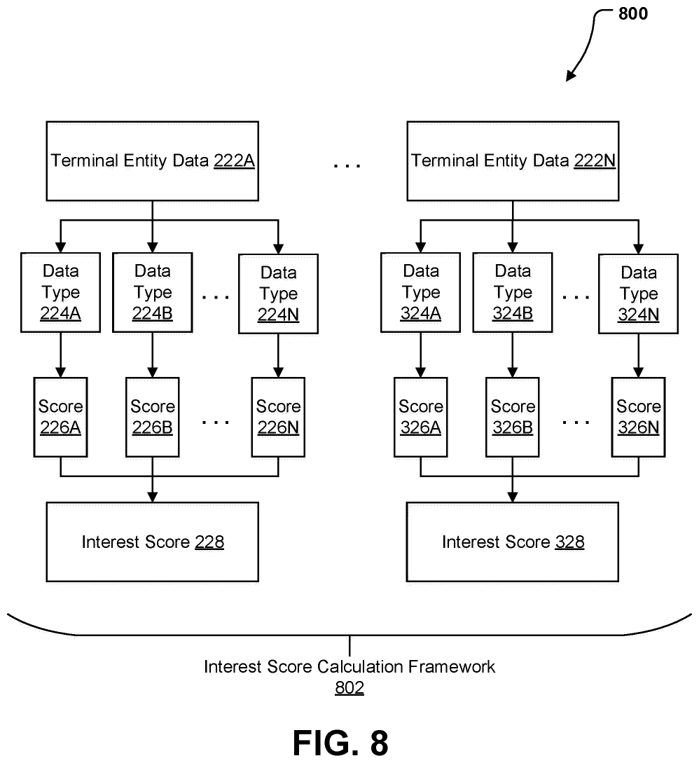

Turning to FIG. 7, a procedure 700 illustrates example operations for outputting a rental prompt to the terminal entity, wherein the apparatus 200 includes means, such as, prospect engine 212, or the like. As shown by operation 702, the prospect engine 212 may search various platforms such as websites, online directories, social media platforms and/or the like to determine the contact information of a terminal entity (e.g., landlord, tenant, rental company, etc.) associated with the ownership or occupancy of the identified rentable unit. In various examples, the contact information may include an email address, phone number, or mailing address. In some examples, the contact information may be stored in an account associated with a digital identity, e.g., corresponding to a username for an individual, group, or business and associated with a website, network, digital service, etc. The prospect engine 212 may also be integrated with external APIs that provide access to contact databases, business directories, or other sources of contact information. In addition, the prospect engine 212 may use third-party data providers to access contact databases. Upon determining contact information of the terminal entity, the prospect engine 212 may use an interest score calculation framework as displayed in FIG. 8 to calculate an interest score for the terminal entity. In various examples, the interest score is a quantifiable measure that assesses the extent of the terminal entity's interest in listing the identified rentable unit for rent.

As shown by operation 704, the apparatus 200 includes means, such as, communications hardware 206, prospect engine 212, or the like, for calculating an interest score for the terminal entity. FIG. 8 describes operation 704 in further detail.

Turning to FIG. 8, a procedure 800 illustrates an interest score calculation framework 802 for calculating an interest score for a terminal entity, wherein the apparatus 200 includes means, such as, memory 204, prospect engine 212, or the like. As shown by this schematic block diagram, the prospect engine 212 may gather one or more terminal entity data 222A-222N and sort this data into different categories depending on the data type 224A-224N and/or 324A-324N. Categories may include terminal entity data such as engagement patterns with rental platforms (e.g., Airbnb or Vrbo), financial goals, credit reports, transaction history, and/or the like. Each data type may contain one or more features that could indicate interest in listing a rentable unit for rent. For instance, a heightened frequency of visits to a rental platform can indicate a heightened interest in listing a rentable unit for rent (e.g., relative to a normalized frequency of visits). The prospect engine 212 may have predefined components that contribute positively or negatively to the interest score and may be assigned a weight from memory 204 (or other storage) that reflects an importance in contributing to the generation of the overall interest score. For instance, in generating the overall interest score for a terminal entity A with a low credit score (e.g., below 620) and high engagement with rental platforms, compared to a terminal entity B with a high credit score (e.g., 720-779) and low engagement with rental platforms, the prospect engine 212 may generate a higher overall interest score for terminal entity A. This may be a result of the prospect engine 212 weighing credit score more heavily than engagement patterns, through which the prospect determined that terminal entity A has a pressing financial need, thereby demonstrating a higher interest in listing their rentable unit for rent. Data type 224A-224N may be normalized, transformed, etc. to ensure that different features are on a consistent scale and can be combined effectively. Each data type may be assigned an individual interest score 226A-226N and/or 326A-326N. The subsequent aggregation of weighted components calculates the interest score 228 and/or 328. Such aggregation may involve summing, averaging, or using more advanced techniques like weighted average, machine learning algorithms, and/or the like. The predefined interest score threshold may be defined based on experimentation and analysis of historical terminal entity data which may indicate the point at which a score indicates sufficient interest of a terminal entity in listing a property for rent.

Returning to FIG. 7, as shown by operation 706, the apparatus 200 includes means such as communications hardware 206, prospect engine 212, or the like, for determining whether the interest score satisfies a predefined interest score threshold. The prospect engine 212 may set the predefined interest score threshold according to the specific goals and preferences of the terminal entity. In some embodiments, the prospect engine 212 may output a rental prompt to the terminal entity via communications hardware 206, even if the interest score does not satisfy a predefined interest score threshold. For instance, if an establishment seeks to maintain user engagement, they may set the rental optimization system 102 to output a rental prompt to a terminal entity with a low interest score, but wherein the rental prompt may align with historical terminal entity interest. In other embodiments, the rental optimization system 102 may allow users to customize the predefined interest score threshold. In such cases, the terminal entity may opt to bypass the interest score calculation completely and always receive a rental prompt. As shown by operation 708, the apparatus 200 includes means, such as,

communications hardware 206, prospect engine 212, or the like, for outputting a rental prompt to the terminal entity. In example embodiments, the prospect engine 212 may completely bypass operation 706 and output a rental prompt to the terminal entity. For instance, if a terminal entity has opted in to receive personalized advertisements or recommendations from an establishment, the prospect engine 212 may output a rental prompt to the terminal entity without calculating their interest score. In other example embodiments wherein the interest score calculation crosses (e.g., exceeds) the predefined interest score threshold, a personalized rental recommendation is generated and a rental prompt based on this personalized rental recommendation is outputted to the terminal entity using communications hardware 206. As discussed in various examples, the rental prompt may include text content. As an example, a rental prompt may be: “You could earn 500$ by renting a room in your property on Tryon St. during the weekend of Jul. 27, 2024, would you like to list this unit for rent?” The prospect engine 212 outputs a rental prompt to the terminal entity and waits for their response. In various other examples, the rental prompt may include images, videos, audio, and/or any combination thereof and text content.

Finally, as shown by operation 710, the apparatus 200 includes means, such as prospect engine 212, or the like, for receiving a response, such as a rental request indicative of an affirmative response to the rental prompt. Once the terminal entity responds affirmatively (e.g., by clicking “Yes” to the example rental prompt, the prospect engine 212 captures the input and triggers variable functions such as data validation, checking for relevant keywords, extracting specific information from the terminal entity's response, and/or the like to process said response). The captured response may then be analyzed by the prospect engine 212 via involvement of algorithms, predefined rules, machine learning models, and/or the like to determine the appropriate next steps or recommendations. The prospect engine 212 may monitor the outcomes of such prompted opportunities to assess their success and adjust the weights in the interest score calculation framework accordingly.

As shown by operation 712, the apparatus 200 includes means, such as, memory 204, communications hardware 206, prospect engine 212, or the like, for generating one or more rental documents for the rentable unit. The one or more rental documents refers to a physical or digital document comprising data fields that may be prefilled from memory 204 and by the communications hardware 206 using the terminal entity data gathered by prospect engine 212. For example, for a residential rentable unit, prefilled data fields may include information regarding (i) brief overview of the property's features and style, (ii) type of property (e.g., apartment, house, condo, etc.), (iii) number of bedrooms and washrooms, (iv) address or general location (e.g., neighborhood, city, or district), (v) proximity to amenities such as schools, public transportation, parks, etc., (vi) rent or lease details (e.g., rent amount, currency, security deposit, upfront fees, lease duration, availability data), (vii) property features (e.g., square footage, flooring, overall condition, appliances, heating and cooling systems), (viii) utilities (e.g., water, electricity, gas internet) that are included in the rent, (ix) availability of parking spaces (e.g., garage, driveway, street parking), (x) amenities (e.g., access to swimming pool, gym, clubhouse, etc.), (xi) pet policy and any associated restrictions or fees, (xii) smoking policy, (xiii) furnished/unfurnished features of the property, (xv) safety and security (e.g., alarms, gated community, surveillance features), (xvi) special features (e.g., fireplaces, balconies, walk-in closets), (xvii) photos and/or virtual tours of the rentable unit, (xviii) contact information that may already be verified, and/or the like. In some embodiments, the prospect engine 212 may send out a second prompt to the terminal entity using communications hardware 206, requesting confirmation that the terminal entity would like to be connected to a rental platform.

As shown by operation 714, the apparatus 200 includes means, such as, memory 204, communications hardware 206, prospect engine 212, or the like, for providing the one or more rental documents to a rental platform. A rental platform may be a digital marketplace, app (e.g., Airbnb or Vrbo) that terminal entities may use to list a rentable unit for rent. The prospect engine 212 may identify whether the rental platform allows external apps to interact with it. If an API is available for an external app, the prospect engine 212 may review its documentation to understand the capabilities and endpoints it offers, and obtain the necessary credentials (e.g., API keys, tokens, etc.) from the app to authenticate the communications hardware's 206 communication with the API of the app. The prospect engine 212 may also be required to define the mapping between the data collected by the prospect engine 212 and the data fields that are expected by the external app. Data formats must match and thus the prospect engine 212 may apply any necessary transformations to the data fields to accomplish this, following which the data may be transmitted from memory 204 and used to autofill relevant fields in the rental platform. In the instance that the API request fails due to validation errors, network errors, database errors, unhandled exceptions, critical failures, user authentication errors, and/or the like, error handling mechanisms may be implemented by the prospect engine 212 to hand cases and provide appropriate feedback to the terminal entity, at which point the terminal entity may be required to manually fill the data fields in the rental platform via communications hardware 206.

As shown by operation 716, the apparatus 200 includes means, such as prospect engine 212, or the like, for ending the rental optimization system by returning to operation 316, should the interest score not satisfy the predefined interest score threshold. In this scenario, the prospect engine 212 may not generate a personalized rental recommendation and may not output a rental prompt based on the personalized rental recommendation to the terminal entity.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide technical solutions designed to systematically inform a terminal entity of opportunities regarding rental optimization of real estate. Such solutions have not previously been used, and are not possible without expressly leveraging the computational power and ubiquity of data available via modern Internet connectivity. Example embodiments allow a terminal entity to list a rentable unit at an appropriate time and appropriate price without the need for manual inspection and constant monitoring, and in a more robust and thorough fashion. Moreover, example embodiments in fact save computational time and resources in comparison to other possible approaches because they generate recommendations and predictions only when deemed warranted by trained machine learning systems. Overall, example embodiments thus enhance the process for renting real estate, while also mitigating both computer resource utilization and eliminating the possibility of human error that would be otherwise unavoidable. Finally, by automating functionality that has historically required human analysis, the speed and consistency of the evaluations performed by example embodiments unlocks many potential new functions that have historically not been available, such as by reacting in substantially real-time to fluctuations in the market that could not historically be accounted for in any systematic fashion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for rental optimization of real estate, the method comprising:
detecting, by an event monitoring engine, an occurrence of a trigger event, wherein the trigger event is associated with a trigger event attribute set, wherein the trigger event attribute set includes a trigger event type and one or more trigger event type attributes;
defining, by the event monitoring engine and based on the trigger event attribute set, an area of interest;
identifying, by a prospect engine, a rentable unit within the area of interest that corresponds to a trigger event type attribute of the one or more trigger event type attributes;
generating, by the prospect engine and based on the trigger event attribute set, a rental price prediction for the rentable unit; and
in an instance in which the rental price prediction satisfies a predefined rental price threshold:
generating, by the prospect engine and based on the rental price prediction, a personalized rental recommendation for the rentable unit, and
outputting, by communications hardware, a rental prompt based on the personalized rental recommendation.

2. The method of claim 1, further comprising:
extracting, by the event monitoring engine, trigger event data from a set of data environments; and
generating, by the event monitoring engine, the trigger event attribute set from the trigger event data.

3. The method of claim 1, wherein defining the area of interest comprises:
determining, by the event monitoring engine and based on the trigger event attribute set, a location associated with the trigger event;
retrieving, by the event monitoring engine, an underlying geography of the determined location;
selecting, by the event monitoring engine and based on the underlying geography, a set of perimeter points within a predefined threshold of distance from the determined location; and
generating, by the event monitoring engine and based on the selected set of perimeter points, a virtual boundary about the determined location.

4. The method of claim 1, further comprising:
aggregating, by a computational engine and from a set of data environments, historical rental data including a plurality of trigger event attribute sets comprising a set of rentable units associated with a plurality of rentable unit types; and
training, by the computational engine and based on the aggregated historical rental data, one or more predictive analytics machine learning models.

5. The method of claim 1, further comprising:
querying, by the prospect engine and based on the trigger event attribute set, a database to identify the rentable unit, wherein the rentable unit is associated with a rentable unit type;
selecting, by the prospect engine, and based on the rentable unit type and the trigger event attribute set, a predictive analytics machine learning model from a set of trained predictive analytics machine learning models; and
deploying, by the prospect engine, the selected predictive analytics machine learning model to generate the rental price prediction for the identified rentable unit.

6. The method of claim 1, further comprising:
determining, by the prospect engine, terminal entity data comprising contact information of a terminal entity associated with ownership or occupancy of the identified rentable unit.

7. The method of claim 1, further comprising:
calculating, by the prospect engine and based on terminal entity data, an interest score for the terminal entity,
wherein the interest score is calculated based on (i) financial data of the terminal entity, (ii) data for the identified rentable unit, (iii) digital engagement patterns of the terminal entity,
wherein the interest score is indicative of a likelihood of the terminal entity responding to a rental prompt, and
wherein the communications hardware outputs the rental prompt in an instance in which the interest score satisfies a predefined interest score threshold.

8. The method of claim 1, further comprising:
receiving, by communications hardware, a rental request, wherein the rental request is indicative of an affirmative response to the rental prompt;
generating, by the prospect engine, one or more rental documents for the rentable unit, wherein the one or more rental documents comprise one or more prefilled data fields; and
providing, by communications hardware, the one or more rental documents to a rental platform.

9. An apparatus for rental optimization of real estate, the apparatus comprising:
an event monitoring engine configured to:
detect an occurrence of a trigger event, wherein the trigger event is associated with a trigger event attribute set, wherein the trigger event attribute set includes a trigger event type and one or more trigger event type attributes, and
define, based on the trigger event attribute set, an area of interest;
a prospect engine configured to:
identify a rentable unit within the area of interest that corresponds to a trigger event type attribute from the one or more trigger event type attributes,
generate, based on the trigger event attribute set, a rental price prediction for the rentable unit, and
in an instance in which the rental price prediction satisfies a predefined rental price threshold:
generate, based on the rental price prediction, a personalized rental recommendation for the rentable unit; and
communications hardware configured to:
output a rental prompt based on the personalized rental recommendation.

10. The apparatus of claim 9, wherein the event monitoring engine is further configured to:
extract trigger event data from a set of data environments; and
generate the trigger event attribute set from the trigger event data.

11. The apparatus of claim 9, wherein the event monitoring engine is further configured to:
determine, based on the trigger event attribute set, a location associated with the trigger event;
retrieve an underlying geography of the determined location;
select, based on the underlying geography of the determined location, a set of perimeter points that satisfy a predefined threshold of distance from the determined location; and
generate, based on the selected set of perimeter points, a virtual boundary about the determined location.

12. The apparatus of claim 9, further comprising a computational engine configured to:
aggregate, from a set of data environments, historical rental data including a plurality of trigger event attribute sets comprising a set of rentable units associated with a plurality of rentable unit types; and
train, based on the aggregated historical rental pricing data, one or more predictive analytics machine learning models.

13. The apparatus of claim 9, wherein the prospect engine is further configured to:
query, based on the trigger event attribute set generated by the event monitoring engine, a database to identify the rentable unit, wherein the rentable unit is associated with the rentable unit type;
select, based on the rentable unit type and the trigger event attribute set, a predictive analytics machine learning model from a set of trained predictive analytics machine learning models; and
deploy the selected predictive analytics machine learning model to generate the rental price prediction for the identified rentable unit.

14. The apparatus of claim 9, wherein the prospect engine is further configured to:
determine terminal entity data comprising contact information of a terminal entity associated with the ownership or occupancy of the identified rentable unit.

15. The apparatus of claim 9, wherein the prospect engine is further configured to:
calculate, based on terminal entity data, an interest score for the terminal entity,
wherein the interest score is determined based on (i) financial data of a terminal entity associated with the identified rentable unit, (ii) data for the corresponding rentable unit, (iii) digital engagement patterns of the terminal entity,
wherein the interest score is indicative of a likelihood of the terminal entity responding to a rental prompt,
wherein the communications hardware is further configured to output the rental prompt in an instance in which the interest score satisfies a predefined interest score threshold.

16. The apparatus of claim 9, wherein the communications hardware is further configured to receive a rental request,
wherein the rental request is indicative of an affirmative response to the rental prompt,
wherein the prospect engine is further configured to generate one or more rental documents for the rentable unit, wherein the one or more rental documents comprise one or more prefilled data fields, and
wherein the communications hardware is further configured to provide the one or more rental documents to a rental platform.

17. A computer program product for rental optimization of real estate, the computer program product comprising at least one non-transitory computer readable storage medium storing software instructions that, when executed, cause an apparatus to:
detect an occurrence of a trigger event, wherein the trigger event is associated with a trigger event attribute set, wherein the trigger event attribute set includes a trigger event type and one or more trigger event type attributes;
define, based on the trigger event attribute set, an area of interest;
identify, a rentable unit within the area of interest that corresponds to a trigger event type attribute from the one or more trigger event type attributes;
generate, based on the trigger event attribute set, a rental price prediction for the rentable unit; and
in an instance in which the rental price prediction satisfies a predefined rental price threshold:
generate, based on the rental price prediction, a personalized rental recommendation for the rentable unit, and
output a rental prompt based on the personalized rental recommendation.

18. The computer program product of claim 17, wherein the software instructions, when executed, further cause the apparatus to:
determine, based on the trigger event attribute set, a location associated with the trigger event;
retrieve an underlying geography of the determined location;
select, based on the underlying geography, a set of perimeter points within a predefined threshold of distance from the determined location; and
generate, based on the selected set of perimeter points, a virtual boundary about the determined location.

19. The computer program product of claim 17, wherein the software instructions, when executed, further cause the apparatus to:
aggregate, from a set of data environments, historical rental data including a plurality of trigger event attribute sets comprising a set of rentable units associated with a plurality of rentable unit types; and
train, based on the aggregated historical rental pricing data, one or more predictive analytics machine learning models.

20. The computer program product of claim 17, wherein the software instructions, when executed, further cause the apparatus to:
query, based on the trigger event attribute set, a database to identify the rentable unit, wherein the rentable unit is associated with the rentable unit type;
select, based on the identified rentable unit type and the trigger event attribute set, a predictive analytics machine learning model from a set of trained predictive analytics machine learning models; and
deploy, the selected predictive analytics machine learning model to generate the rental price prediction for the identified rentable unit.
